(19) United States
(12) Patent Application Publication
(10) Pub. No.: US 2003/0044545 A1
(43) Pub. Date: Mar. 6, 2003

(54) Hold-down bar and apparatus and method for coating continuous material

(76) Inventors: Brian W. Ables, Reynoldsburg, OH (US); James E. Wille, Gahanna, OH (US)

Correspondence Address: OWENS CORNING, 2790 COLUMBUS ROAD, GRANVILLE, OH, 43023, US

(21) Appl. No.: 09/943,608

(22) Filed: Aug. 30, 2001

(51) Int. Cl. B05D 1/18

(52) U.S. Cl. 427/430.1; 118/419; 118/423

(57) ABSTRACT

The present invention is directed towards an apparatus for treating continuous materials. In one embodiment of the invention, a mounting bar is supported between mounting brackets. Tubing is mounted for rotation to the mounting bar. A first rod extends radially from the tubing and is adapted to rotate with the tubing. A second rod is supported by the first rod. A contact supported by an end of the second rod is adapted to orbit around the mounting bar upon rotating the first rod. In another embodiment of the invention, an application pan is provided. A guide is provided at a front end of the pan and a stripper die is provided at a rear end of the pan. A hold-down bar located between the front and rear ends of the pan is adapted to be rotated about an axis that extends laterally relative to the application pan. A strand rod is located between the hold-down bar and the stripper die. In yet another embodiment of the invention, a method is provided for immersing a length of continuous material into an application pan containing liquid. The method comprises the steps of lifting a hold-down bar up out of an application pan, threading a length of continuous material, and pivoting the hold-down bar down to immerse the continuous material into the liquid contained in the pan.

### TECHNICAL FIELD AND INDUSTRIAL APPLICABILITY OF THE INVENTION

This invention relates in general to an apparatus for treating continuous materials, and in particular, to an apparatus for impregnating continuous lengths of materials, such as glass, carbon or other known filaments or fibers, by immersion in a aqueous or resinous liquid, such as molten epoxy or polymeric resin, to produce reinforced products.

### BACKGROUND OF THE INVENTION

When producing continuous materials, it is well known to treat the continuous materials by immersing the materials in a liquid bath. To do this, the continuous materials are generally immersed in the treatment bath by passing the materials under pulleys or cylindrical hold-down bars which are partially or completely immersed and which may be fixed or rotating. This leads to considerable difficulties when it is desired to pass the materials under these pulleys or hold-down bars manually, especially when the treatment bath is hot, corrosive or toxic.

In order to facilitate this immersion process and to make it unnecessary for the operator to have to put his hands in the bath, the bath is drained to permit the operator to thread the materials under the pulleys or cylindrical hold-down bars. It has been proposed to mount the cylindrical hold-down bars on a frame which is held above the tank when the continuous materials are passing horizontally and which is then lowered in order to immerse the continuous materials into the bath. This solution is expensive. Moreover, it places the continuous materials under excessive tension when the materials are lowered into the bath.

The present invention overcomes these disadvantages. It relates to an apparatus that is simple and easy to manipulate, that makes it unnecessary for the operator to put his hands in the tank in order to pass the continuous materials under the hold-down bars, and that does not place the materials under excessive tension when the materials are lowered into the bath.

### SUMMARY OF THE INVENTION

The above objects, as well as other objects not specifically enumerated, are achieved by an apparatus and method for treating continuous materials. In one embodiment of the invention, a mounting bar is supported between mounting brackets. Tubing is mounted for rotation to the mounting bar. A first rod extends radially from the tubing and is adapted to rotate with the tubing. A second rod is supported by the first rod. A contact supported by an end of the second rod is adapted to orbit around the mounting bar upon rotating the first rod.

In another embodiment of the invention, an application pan is provided. A guide is provided at a front end of the pan and a stripper die is provided at a rear end of the pan. A hold-down bar located between the front and rear ends of the pan is adapted to be rotated about an axis that extends laterally relative to the application pan. A strand rod is located between the hold-down bar and the stripper die.

In yet another embodiment of the invention, a method is provided for immersing a length of continuous material into an application pan containing liquid. The method comprises the steps of lifting a hold-down bar up out of an application pan, threading a length of continuous material, and pivoting the hold-down bar down to immerse the continuous material into the liquid contained in the pan.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a side elevational view of an apparatus for treating lengths of continuous materials wherein one hold-down bar of the apparatus is lifted up and the remaining hold-down bars are pivoted down.

FIG. 2 is a front elevational view of the apparatus shown in FIG. 1.

FIG. 3 is a top plan view of the apparatus shown in FIGS. 1 and 2.

FIG. 4 is an enlarged front elevational view of a pair of flanged pins supported on a hold-down bar of the apparatus shown in FIGS. 1-3.

FIG. 5 is an enlarged front elevational view of a pair of pulleys, which can be used in place of the pins shown in FIG. 4.

FIG. 6 is an enlarged side elevational view of a hold-down bar according to the present invention supporting the pulleys in the place of pins.

FIG. 7 is a side elevational view of the hold-down bar shown in FIG. 6.

FIG. 8 is an enlarged side elevational view of a handle on the hold-down bar shown in FIGS. 6 and 7.

FIG. 9 is an enlarged, partial side elevational view of the apparatus shown in FIGS. 1-3 with the hold-down bar pivoted down and in a latched position.

FIG. 10 is a block diagram of the method for treating lengths of continuous materials.

FIG. 11 is a block diagram of the threading step shown in FIG. 10.

FIG. 12 is a block diagram of the rethreading step of FIG. 11.

### DETAILED DESCRIPTION OF THE PREFERRED EMBODIMENT

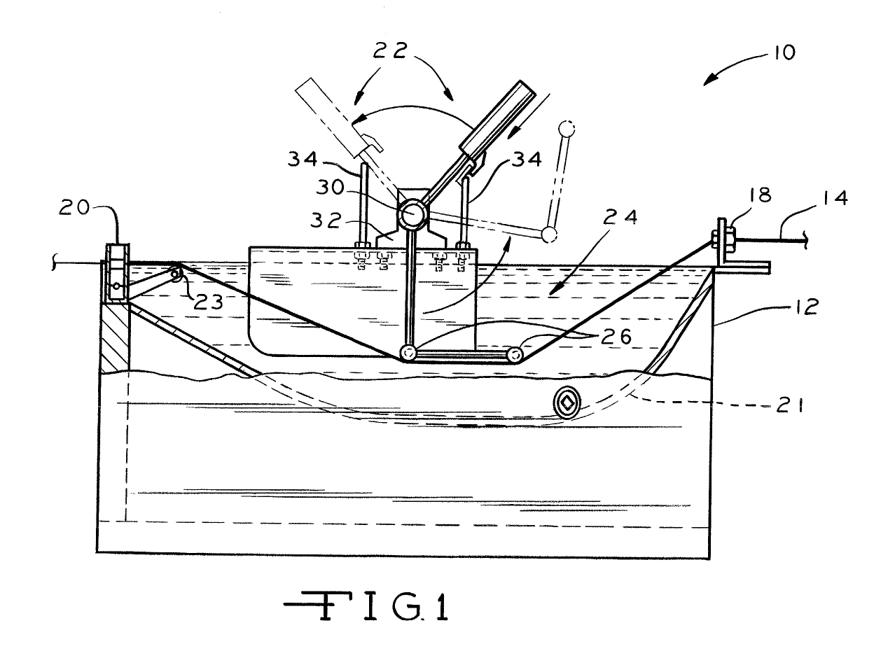

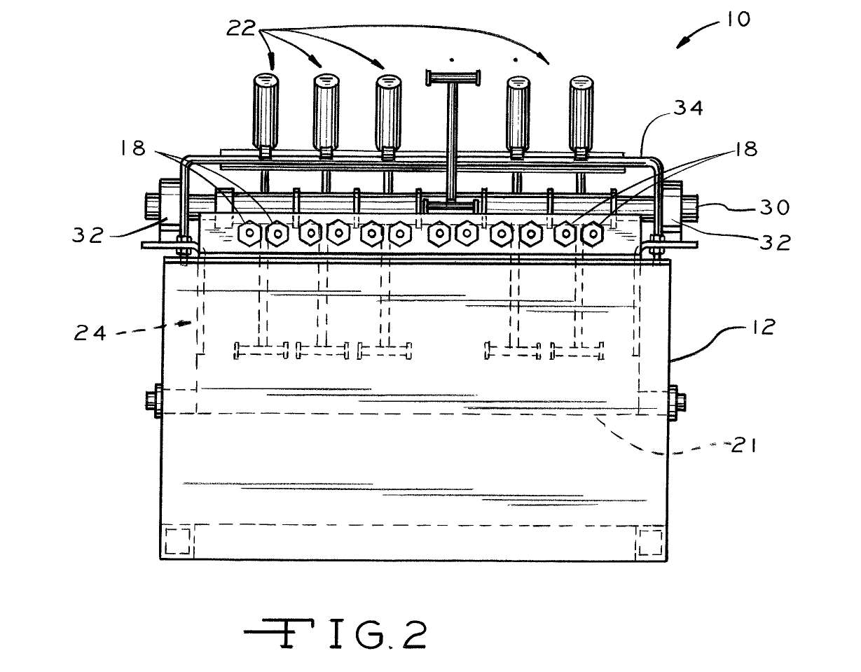

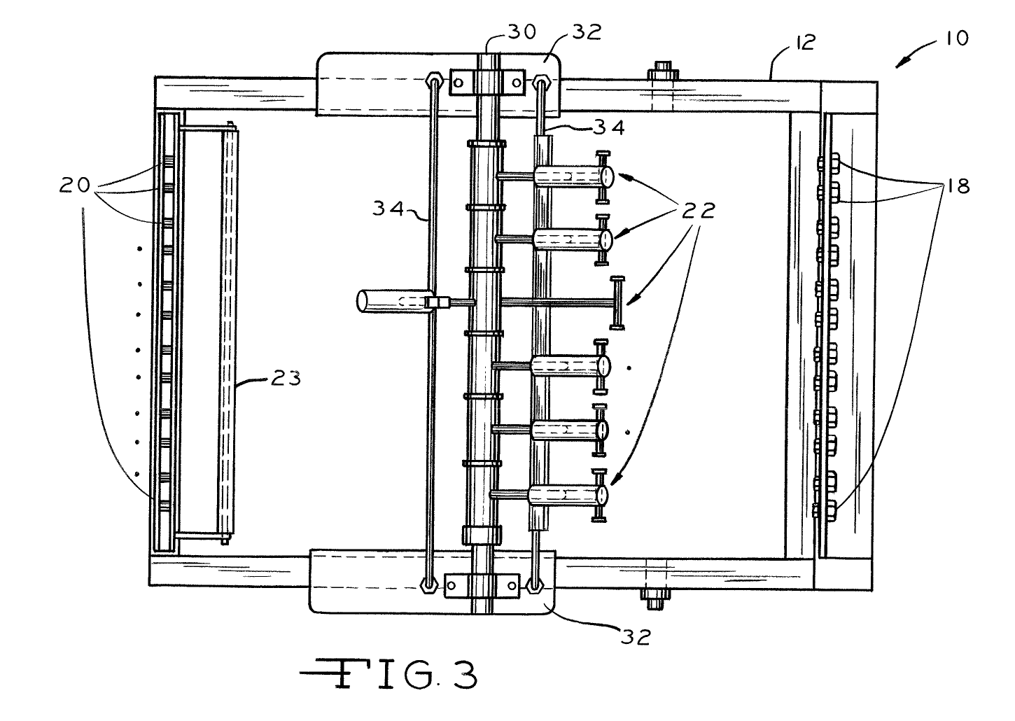

Referring now to the drawings, there is illustrated in FIGS. 1-3 an apparatus 10 for treating continuous materials 14 to produce reinforced products. The apparatus 10 is basically comprised of a tank or application pan, generally indicated at 12, situated between a source of continuous materials 14 and a bobbin or mandrel (not shown). Guides 18 are provided at a front end of the pan 12. Stripper dies 20 are provided at the rear end of the pan 12. Immersible retaining or hold-down bars 22 are located between the front and rear ends of the pan 12. A strand rod 23 is located between the hold-down bars 22 and the stripper dies 20.

The pan 12 is preferably in the form of an elongate vessel or container, which is substantially rectangular in shape. The pan 12 preferably has a contour as illustrated with a generally horizontal bottom surface and four substantially vertical walls that are adapted to contain a quantity of liquid 24, such as a fast-setting aqueous solution or a catalyzed or non-catalyzed epoxy or polyester resin. The liquid 24 can be heated by a furnace or heating elements 21. The heating elements 21 can be in the form of electric rods, electric heat strips or a hot oil jacket for heating the pan 12 to maintain a heated liquid or molten resin within the confines of the pan 12. The pan 12 may be provided with a drain through which the liquid 24 may be drained. The pan 12 may be provided with an inlet through which the liquid 24 may be refilled. The pan 12 has an open top through which continuous materials 14 may be guided into the liquid 24.

The source of continuous materials 14 may include but is not necessarily limited to strands, rovings, yarns, tows, tapes, or the like. The continuous materials 14 may be round, flat or some other shape. The continuous materials 14 may be impregnated with liquid 24 by advancing the materials 14 through the liquid 24 contained in the application pan 12. The impregnated materials 14 are wound onto the mandrel that is mounted for rotation downstream of the pan 12. The term “downstream” is intended to be interpreted as relative to the forward direction of the material 14 guided through the pan 12. The continuous material 14 is advanced through the pan 12 by pulling the material 14 onto the mandrel.

The continuous materials 14 are guided through the guides 18 prior to being immersed into the liquid 24. The guides 18 are preferably provided for clustering the individual continuous materials 14 together in laterally spaced pairs. The guides 18 direct the materials 14 toward the open top of the pan 12. The materials 14 are preferably clustered in pairs to reduce the number of packages to creel. However, it should be appreciated that the guides 18 can guide the materials 14 individually or in numbers greater than two.

Once impregnated, the continuous materials 14 are threaded through the stripper dies 20, which remove excess liquid 24 from the impregnated materials 14. The stripper dies 20 regulate the size of the impregnated materials 14. It should be appreciated that squeegees and other types of wipers may be suitable for removing excess liquid 24 as well.

The strand rod 23 is provided for guiding the impregnated continuous materials 14 into the stripper dies 20. The top surface of strand rod 23 is preferably aligned with the center of the stripper dies 20 so that the continuous materials 14 are directed straight into the dies 20. This more accurately regulates the size of the impregnated materials 14.

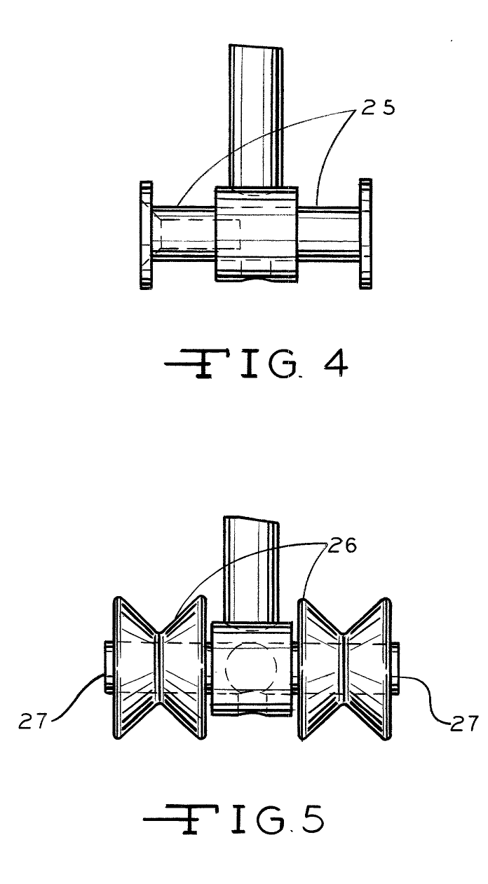

The hold-down bars 22 are laterally spaced for guiding the individual continuous materials 14 along the length of the pan 12 separately and in parallel relation to each other to impregnate the materials 14 with liquid 24. The hold-down bars 22 are provided for controlling the depth at which the materials 14 are immersed. Each hold-down bar 22 is fitted with at least one guide point or contact. Contacts are preferably in the form of pins 25 or pulleys 26, as shown in FIGS. 4 and 5. The pins 25 enable the apparatus 10 to be used in a pulley-less operation. In a preferred embodiment of the invention, the pins 25 are preferably provided with flanges that retain the continuous material 14 on the pins 25. The flanged pins 25 are interchangeable with transverse pins 27. The pulleys 26 are preferably mounted for rotation on the transverse pin 27. The pulleys 26 can be held on the transverse pin 27 by C-clips (not shown) or any other suitable fastener. The pulleys 26 are driven by movement of the material 14 being guided through the pan 12 and can be lubricated by the liquid 24 contained in the pan 12. Each hold-down bar 22 may support multiple pins 25 or pulleys 26. In a preferred embodiment of the invention, each length of continuous material 14 is supported by two longitudinally spaced pins 25 or pulleys 26. However, more or less than two pins 25 or pulleys 26 may be suitable for carrying out the invention. The number of pins 25 or pulleys 26 used depends on the resonance time required for the continuous material 14 in the liquid 24.

Although the pins 25, 27 and pulleys 26 shown can be made of polished steel or any other material, the pins 25, 27 and pulleys 26 are preferably made of ceramic. Ceramic is a low abrasion material that reduces tension and thus offers less damage to the continuous materials 14 being impregnated. Hence, ceramic pins 25, 27 and pulleys 26 may result in fewer broken continuous materials. A controlled amount of tension is desirable because a certain amount of tension is required to open the continuous material 14 to accept the liquid 24, or to impregnate the continuous material 14.

Means are provided for coupling the hold-down bars 22 to a mounting bar 30 that is laterally supported between a pair of laterally spaced mounting brackets 32, which allow the mounting bar 30 to be retrofitted on existing pans or mounted on new construction. In a preferred embodiment of the invention, the hold-down bars 22 are mounted for rotation on the mounting bar 30. This permits the hold-down bars 22 to revolve and thus be lifted up or pivoted downward about the mounting bar 30. In this way, the contacts (i.e., the pins 25 or pulleys 26) are adapted to orbit around the mounting bar 30. Although it is preferable that the hold-down bars 22 may be rotated manually by an operator, it should be appreciated that the bars 22 may be rotated by a rotating means, such as a hoisting mechanism (not shown) which includes a drive mechanism and a clutch for effecting movement of the hold-down bars 22 by the drive mechanism.

In a preferred embodiment of the invention, a stop bar 34 is provided for limiting the movement of the hold-down bars 22. The stop bar 34 is provided in front of the mounting bar 30 to limit the downward movement of the hold-down bars 22. The same stop bar 34 can limit the movement of the hold-down bars 22 when the hold-down bars 22 are being lifted up. It should be appreciated that a stop bar 34 can be provided to the rear of the mounting bar 30 to limit the movement of the hold-down bars 22 when the hold-down bars 22 are being lifted up. It should be appreciated that the present invention is not intended to be limited to the stop bars 34 shown and that any other suitable stop may be used for limiting the movement of the hold-down bars 22.

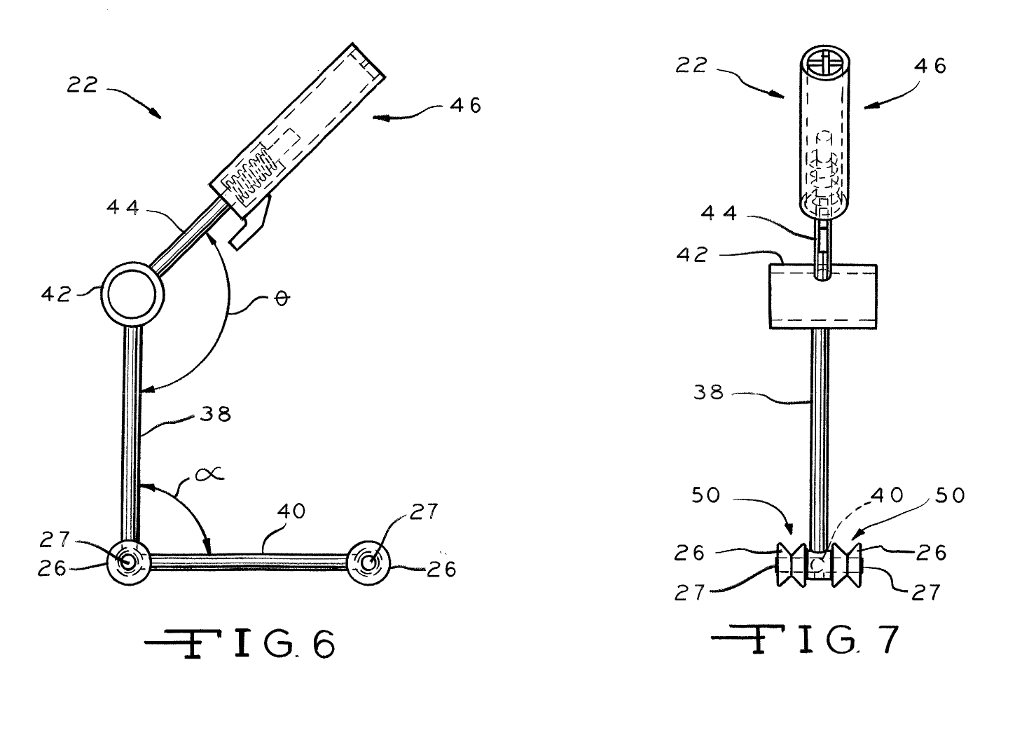

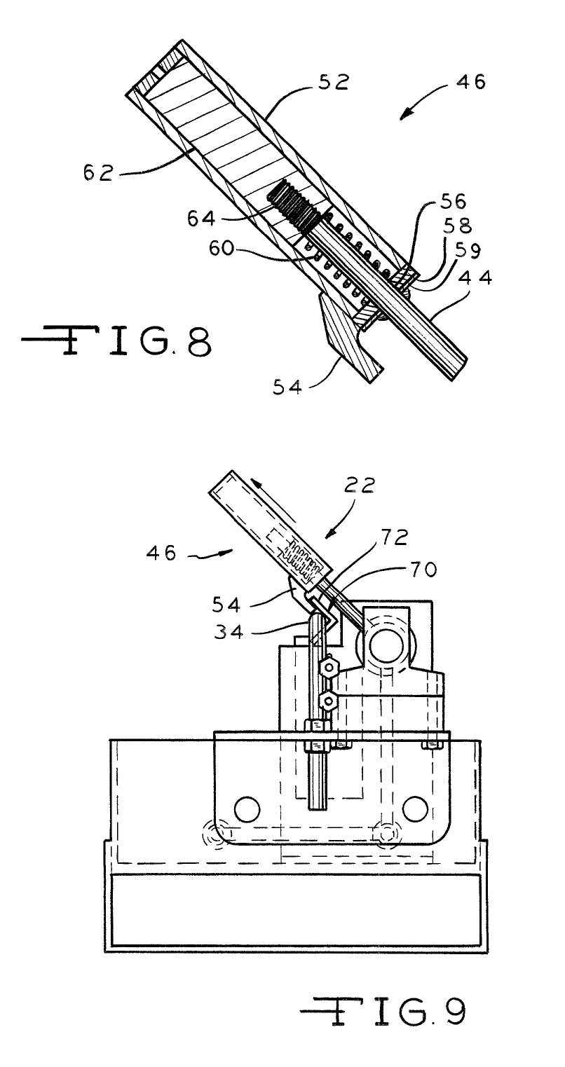

Now with reference to FIGS. 6 and 7, the hold-down bar 22 will be described in greater detail. The hold-down bar 22 is comprised of a first rod 38 that is provided for supporting pulleys 26. In a preferred embodiment of the invention, the first rod 38 supports a second rod 40. The second rod 40 is preferably cantilevered relative to the first rod 38. Opposing ends of the second rod 40 have pins 27 extending laterally therefrom. The pulleys 26 are mounted for rotation on opposing ends of each pin 27. Each pulley 26 is provided with an annular groove 50 for receiving and thus guiding or supporting continuous material 14. The first rod 38 is supported by a pivot member, such as the tubing 42 shown. As shown in the drawings, the first rod 38 may extend radially from the tubing 42. The tubing 42 is adapted to be mounted for rotation to the mounting bar 30. That is to say, the tubing 42 is adapted to rotate about an axis that extends laterally relative to the application pan 12. In a preferred embodiment of the invention, a third rod 44 is supported by the tubing 36. As shown in the drawings, the third rod 44 may extend radially from the tubing 36 similar to the first rod 38. The third rod 44 is preferably provided for supporting a handle, generally indicated at 46. The handle 46 is adapted for use by an operator for controlling the movement of the hold-down bar 22. The handle 46 is also preferably weighted to function as a counter balance to aid the operator in moving the hold-down bar 22. The third rod 44 is adapted to engage the stop bars 34 to limit the movement of the hold-down bar 22.

In the most preferred embodiment of the invention, the second rod 40 is substantially horizontal in orientation when the hold-down bar 22 is pivoted down. When the hold-down rod 22 is in the same position, the first rod 38 is substantially vertical in orientation. The vertical orientation of the first rod 38 permits the position of the second rod 40 with respect to the bottom surface of the pan 12 to easily be determined. Hence, it follows that the angle α between the first and second rods 38 and 40 is preferably about 90 degrees. It should be appreciated that the lengths of the first and second rods 38 and 40 are dependent on the pan's 12 design. However, the longer the first rod 38, the larger the radius of travel of the second rod 40. It should also be appreciated that the clearance between the pulleys 26 and the bottom surface of the pan 12 is largely dependent on the length of the first rod 38. It should be noted that the first rod 38 is downstream of the second rod 40 and that the hold-down bar 22 pivots upstream of the first rod 38. This relative position of elements maximizes the clearance between the second rod 40 and the bottom surface of the pan 12.

With regard to the relative positions of the first and third rods 38 and 44, the angle θ between the first and third rods 38 and 44 is dependent upon the dimensions and relative positions the third rod 44 and the stop bars 34. That is to say, the angle θ between the first and third rods 38 and 44 can easily be established if the dimensions and relative positions the third rod 44 and the stop bar 34 are known.

Now with reference to FIG. 8, the handle 46 will be described in greater detail. In a preferred embodiment of the invention, the handle 46 is in the form of a release handle comprised of a tubing 52 having a latch element 54 extending radially from a lower end thereof. An upper end of the third rod 44 is inserted through a hole 56 in a wall 58 at the lower end of the tubing 52. Travel of the third rod 44 within the hole 56 is limited by a stop, such as the washer 59 shown, fixed to the third rod 44. Hence, the travel of the third rod 44 is limited relative to the tubing 52. A spring 60 is carried by the upper end of the third rod 44. A handle cap 62 is inserted in an upper end of the tubing 52. A lower end of the cap 62 has a hole 64. A portion of the upper end of the third rod 44 is pressed or threaded into the hole 64. The spring 60 is retained in a cavity defined by the tubing 52 between the wall 58 at the lower end of the tubing 52 and the lower end of the cap 62. The tubing 52 is adapted to be pulled up axially relative to the third rod 44 in opposition to the spring 60. That is to say, as the tubing 52 is pulled, the spring 60 is compressed. Upon releasing the tubing 52, the compressed spring 60 urges the tubing 52 back down.

Means can be provided for maintaining the position of the latch 54 in a substantially fixed radial position relative to the third rod 44. This may be accomplished in any suitable manner. For example, a transverse pin (not shown) can be supported by the third rod 44. The transverse pin passes through the third rod 44. The lower end of the tubing 52 can be provided with opposing slots (also not shown) for receiving opposing ends of the pin. The slots extend in a direction parallel to the central axis of the tubing 52. The opposing ends of the pin cooperate with the slots to prevent the tubing 52 from twisting relative to the third rod 44. This prevents the latch 54 from moving about the third rod 44. It should be noted, however, that the opposing ends of the pin are capable of moving in the slots in directions parallel to the central axis of the third rod 44. This permits the tubing 52 to move axially relative to the third rod 44. This maintaining means may not be necessary if the spring 60 is under sufficient tension. The tension of the spring 60 may function to keep the tubing 52 from twisting.

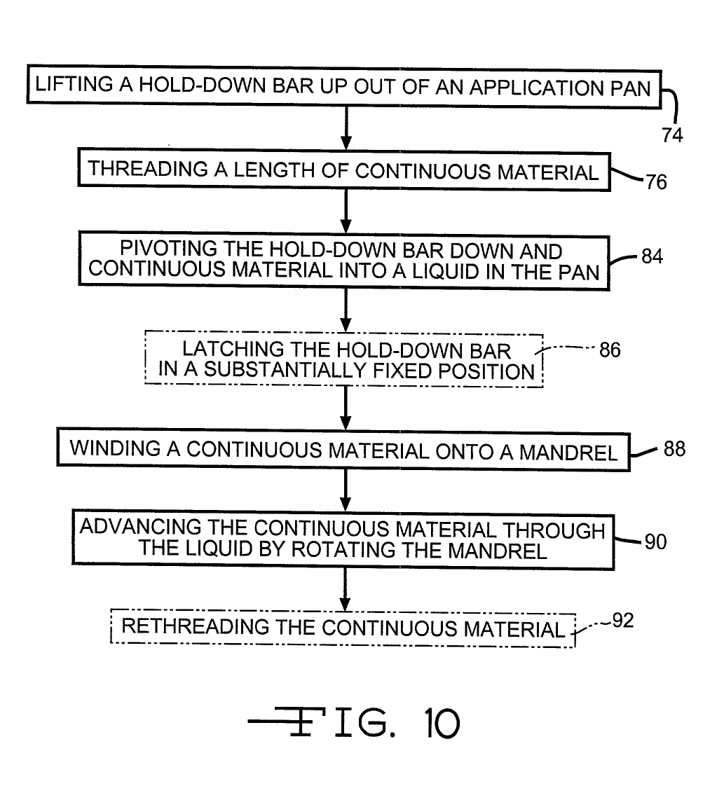

In a preferred embodiment of the invention, the latch 54 is adapted to engage the stop bar 34, as shown in FIG. 9. The stop bar 34 is preferably in the form of an inverted U-shaped member, such as the round stock shown, which carries an elongate piece of angle stock, generally indicated at 70. A portion 72 of the angle stock 70 extends in a plane that is substantially parallel to the central axis of the tubing 52 of the handle 46 when the hold-down bar 22 is pivoted downward to immerse the continuous material 14. This portion 72 of the angle stock 70 is adapted to fit in a space defined between the latch 54 and the lower end of the tubing 52. This is accomplished by pulling the tubing 52 upward. Upon releasing the tubing 52, the spring 60 urges the tubing 52, and in turn the latch 54 back down to trap the portion 72 of the angle stock 70 in the space.

The above-described latch 54 always latches in substantially the same position and thus has reliable repeatability. Moreover, the latch 54 is self-locking and is easy to unlock for expediency. For at least these reasons, the above-described latch 54 is preferred. However, it should be understood that the present invention is not intended to be limited to the latch 54 shown and that other latches may likewise be suitable for carrying out the invention. Moreover, the invention is not intended to be limited to the handle 46 shown and that other handles can be suitable for carrying out the invention.

It should also be appreciated that the hold-down bar 22 has application with apparatus other than the one described above. It should also be appreciated that other hold-down bars may be contemplated for carrying out the invention and that the present invention is not necessarily intended to be limited to the hold-down bar 22 shown.

In operation, the hold-down bar 22 is initially lifted up. Continuous material 14 from a source of continuous material 14 is threaded through one of the guides 18. The continuous material 14 from the source is often referred to as a “carrier strand”. The continuous material 14 is pulled across the application pan 12, under pulleys 26 supported by the hold-down bar 22, over the strand rod 23, and through one of the stripper dies 20. The hold-down bar 22 is pivoted down to immerse the continuous material 14 into the liquid 24 contained in the pan 12. When pivoted down, the hold-down bar 22 is adapted to be latched in a substantially fixed position. Next, the continuous material 14 is then wound onto a mandrel. The mandrel is mounted for rotation. As the mandrel rotates, the continuous material 14 is pulled or advanced across the pan 12 through the liquid 24.

As stated above, each hold-down bar 22 can support two pairs of laterally spaced pulleys 26. The laterally spaced pulleys 26 are adapted to support a laterally spaced pair of continuous materials 14, which are often referred to as “partner strands”. If one length of continuous material 14 breaks, advancement of that pair of materials 14 can be stopped. The broken length of the continuous material 14 can be rethreaded through the guide 18 and die 20 and wound on a new mandrel. In doing so, the hold-down bar 22 for that pair of materials 14 is lifted up out of the liquid 24 while the materials 14 are threaded through the guide 18 and the die 20. After the continuous materials 14 have been rethreaded, the hold-down bar 22 is pivoted down to immerse the materials 14 in the liquid 24.

As stated above, a number of laterally spaced hold-down bars 22 can be provided. Unbroken pairs of continuous materials 14 may continue to be advanced through the liquid 24 while a broken pair of continuous materials 22 is being rethreaded. This prevents the entire production of reinforced products from being interrupted by rethreading a single pair of continuous materials 14. In other words, the present invention permits on-the-fly rethreading. Since the hold-down bar 22 can be lifted out of the liquid 24, risk of an operator contacting the liquid 24 is reduced.

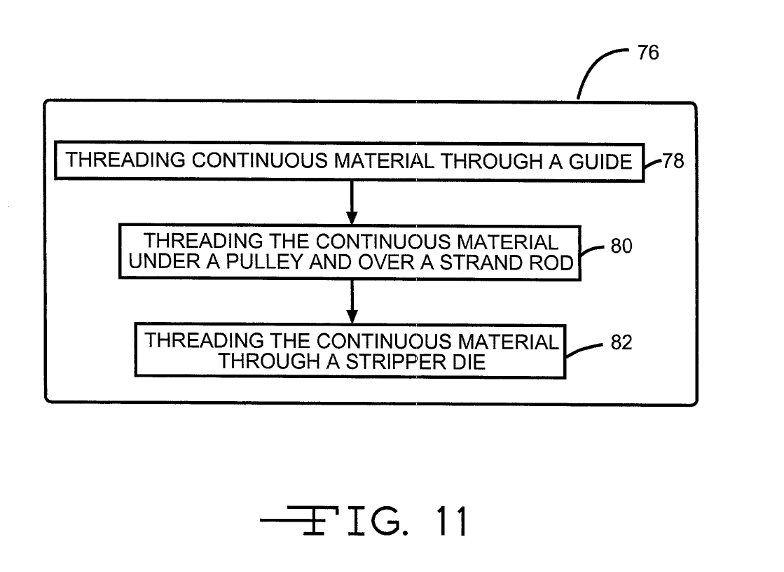

A method according to the present invention will now be described with reference to FIG. 10. The method is first comprised of a lifting step 74 wherein a hold-down bar 22 is lifted up out of an application pan 12 containing a liquid 24 for treating a length of continuous material 14. The method next comprises a threading step 76. The threading step 76 comprises three steps 78, 80, and 82. In a first threading step 78, a length of continuous material 14 from a source of continuous material 14 is threaded through a guide 18. In a second threading step 80, the continuous material 14 is next threaded under at least one contact (e.g., a pin 25 or a pulley 26) supported by the hold-down bar 22 and then over a strand rod 23. In a third threading step 82, the continuous material 14 is finally threaded through a stripper die 20. The method next comprises a pivoting step 84 wherein the hold-down bar 22 is pivoted down to immerse the pulley 26 and the continuous material 14 into the liquid 24 contained in the pan 12. The method can further be comprised of a latching step 86 wherein the hold-down bar 22 is latched in a substantially fixed position. The method further comprises a winding step 88 wherein the continuous material 14 is next wound onto a mandrel. The method yet further comprises an advancing step 90 wherein the continuous material 14 is advanced through the liquid 24 contained in the pan 12 by rotating the mandrel.

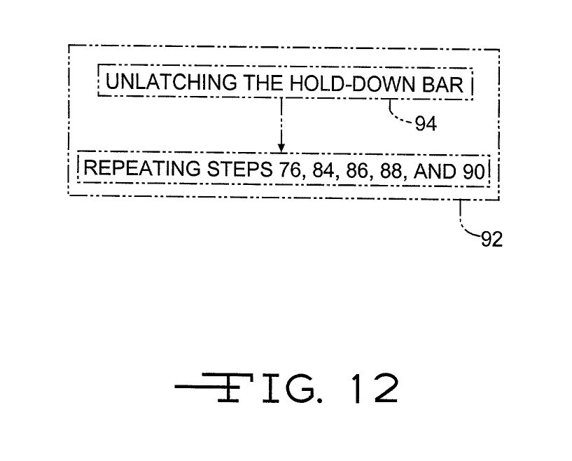

If the length of continuous material 14 breaks, the method includes an optional rethreading step 92. As shown in FIG. 11, the rethreading step 92 includes an unlatching step 94, wherein the hold-down bar 22 is unlatched and the threading step 76, the pivoting step 84, the latching step 86, and the winding step 88 are repeated. Following the rethreading step 92, the continuous material 14 can once again be advanced through the liquid 24 contained in the pan 12 by rotating the mandrel.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. An apparatus for immersing a length of continuous material into an application pan containing liquid, the hold-down bar comprising:
a pair of laterally spaced mounting brackets;
a mounting bar laterally supported between the mounting brackets;
tubing mounted for rotation to the mounting bar, the tubing being adapted to rotate about a laterally extending axis; and
a hold-down bar comprising:
a first rod extending radially from the tubing, the first rod being adapted to rotate with the tubing about the laterally extending axis;
a second rod supported by the first rod, the second rod having an end; and
a contact supported by the end of the second rod, the contact being adapted to orbit around the mounting bar upon rotating the first rod.

2. The apparatus of claim 1, wherein the second rod is cantilevered relative to the first rod.

3. The apparatus of claim 1, wherein the contact includes a laterally extending shaft located at the end of the second rod.

4. The apparatus of claim 1, further including a plurality of laterally spaced contacts including the at least one contact, wherein the second rod includes another end and the contacts include a pair of laterally extending pins located at each of the ends of the second rod.

5. The apparatus of claim 1, wherein the contact includes a pulley mounted for rotation on the end of the second rod.

6. The apparatus of claim 1, further including a plurality of laterally spaced contacts including the at least one contact, wherein the second rod includes another end and the contacts include a pair of laterally extending pulleys mounted for rotation on each of the ends of the second rod.

7. The apparatus of claim 1, wherein the pulley is provided with an annular groove for receiving continuous material.

8. The apparatus of claim 1, wherein the second rod is supported at a 90 degree angle relative to the first rod.

9. The apparatus of claim 1, further including a third rod extending from the tubing, the third rod supporting a handle that is adapted for use by an operator for controlling the movement of the first rod.

10. The apparatus of claim 9, wherein the handle is weighted to function as a counter balance to aid the operator in moving the first rod.

11. The apparatus of claim 9, further including a stop bar laterally supported between the mounting brackets, the third rod being adapted to engage the stop bar to limit movement of the first rod.

12. The apparatus of claim 11, wherein the handle is in the form of a release handle comprised of:
a tubing having a lower end, a wall with a hole therein at the lower end, and a latch element extending radially from the lower end, the third rod having an upper end inserted through the hole and into the handle tubing, the third rod having a stop fixed thereto to limit travel of the third rod relative to the handle tubing;
a spring carried by the upper end of the third rod; and
a handle cap inserted in an upper end of the handle tubing, the cap having a lower end having a hole therein, a portion of the upper end of the third rod being pressed into the hole, the spring being retained in a cavity defined by the handle tubing between the wall at the lower end of the tubing and the lower end of the cap, the tubing being adapted to be pulled up axially relative to the third rod in opposition to the spring, the latch being adapted to engage the stop bar.

13. The apparatus of claim 12, wherein the stop bar is in the form of an inverted U-shaped member which carries an elongate piece of angle stock, a portion of the angle stock being adapted to fit in a space defined between the latch and the lower end of the tubing to trap the portion of the angle stock in the space.

14. The apparatus of claim 12, further including means for maintaining the latch in a substantially fixed radial position relative to the third rod.

15. The apparatus of claim 12, further including:
a transverse pin supported by the third rod; and
a slot in the lower end of the handle tubing, the slot receiving the pin to prevent the handle tubing from twisting relative to the third rod.

16. The apparatus of claim 15, wherein the pin is adapted to move in the slot in a direction parallel to a central axis of the third rod to permit the handle tubing to move axially relative to the third rod.

17. An apparatus for treating a length of continuous material, the apparatus comprising:
an application pan that is adapted to contain a quantity of liquid, the pan having an open top through which continuous materials are adapted to be guided into the pan;
at least one guide provided at a front end of the pan through which continuous materials are adapted to be guided;
at least one stripper die provided at the rear end of the pan which are adapted to remove excess liquid from the continuous materials;
a hold-down bar located between the front and rear ends of the pan, the hold-down bar being adapted to rotate about an axis that extends laterally relative to the application pan; and
a strand rod located between the hold-down bar and the stripper die for guiding the continuous materials into the stripper dies.

18. The apparatus of claim 17, further including a plurality of laterally spaced guides including the at least one guide, a plurality of laterally spaced stripper dies including the at least one stripper die, and a plurality of laterally spaced hold-down bars including the at least one hold-down bar.

19. The apparatus of claim 18, wherein each one of the hold-down bars is fitted with a pair of guide pulleys.

20. The apparatus of claim 19, wherein the pulleys are made of polished steel.

21. The apparatus of claim 19, wherein the pulleys are removable.

22. The apparatus of claim 19, wherein the pulleys are made of ceramic.

23. The apparatus of claim 18, wherein each one of the hold-down bars is fitted with a pair of flanged pins.

24. The apparatus of claim 17, further including laterally spaced brackets and a mounting bar that is supported on the laterally spaced mounting brackets, the hold-down bar being mounted for rotation on the mounting bar.

25. The apparatus of claim 24, further including a stop bar for limiting movement of the hold-down bar, the stop bar being provided in front of the mounting bar to limit the downward movement of the hold-down bar.

26. The apparatus of claim 25, further including another stop bar provided to the rear of the mounting bar to limit the movement of the hold-down bar when the hold-down bars are being lifted up.

27. A method for immersing a length of continuous material into an application pan containing liquid, the method comprising the steps of:
a) lifting a hold-down bar up out of an application pan;
b) threading a length of continuous material; and
c) pivoting the hold-down bar down to immerse the continuous material into the liquid contained in the pan.

28. The method of claim 27, following step c), further comprising the step of:
d) latching the hold-down bar in a substantially fixed position.

29. The method of claim 27, following step c), further comprising the steps of:
d) winding the continuous material onto a mandrel; and
e) rotating the mandrel to advance the continuous material through the liquid.

30. The method of claim 27, wherein the threading step further comprises the steps of:
i) threading the continuous material through a guide;
ii) threading the continuous material under a contact supported by the hold-down bar; and
iii) threading the continuous material through a stripper die.

31. The method of claim 30, wherein step ii) further comprising the step of threading the continuous strand over a strand rod.
